(19) United States
(12) Patent Application Publication
(10) Pub. No.: US 2019/0330066 A1
(43) Pub. Date: Oct. 31, 2019

(54) METHOD OF SYNTHESIZING N-DOPED GRAPHITIC CARBON NANOPARTICLES, METHOD OF DETECTING MERCURY IONS IN AQUEOUS SOLUTION, CELL IMAGING METHOD, ELECTRICALLY CONDUCTIVE MATERIAL AND INFRARED EMITTING DEVICE

(71) Applicant: Chien-Te Hsieh, Taoyuan (TW)

(72) Inventors: Chien-Te HSIEH, Taoyuan (TW); Si-Yong Gu, Xiamen (CN); Yu-Fu Chen, Taoyuan (TW)

(21) Appl. No.: 15/962,117

(22) Filed: Apr. 25, 2018

(51) Int. Cl. C01B 32/194; G01N 21/69

(52) U.S. Cl. CPC C01B 32/194; B82Y 30/00; G01N 21/69

(57) ABSTRACT

A method of synthesizing N-doped graphitic carbon nanoparticles is disclosed. A mixture includes a carbon-containing compound and a nitrogen-containing compound providing. The mixture is heated by microwaves to implement a synthesizing procedure, thereby obtaining a plurality of N-doped graphitic carbon nanoparticles.

### TECHNICAL FIELD

The present disclosure relates to a method of synthesizing carbon nanoparticles, more particularly to a method of synthesizing N-doped graphitic carbon nanoparticles. The present disclosure further relates to applications of the N-doped graphitic carbon nanoparticles, including a method of detecting mercury ions in aqueous solution, a cell imaging method, an electrically conductive material, and an infrared emitting device.

### BACKGROUND

An ideal two-dimensional graphitic single layer (graphene sheet), which consists of sp2-hybridized carbon atoms, is known as a zero-bandgap semiconductor. To manipulate the band gap of graphitic carbon, a strategy is to reduce the particle size down to the nanoscale, thereby altering the band structure due to quantum confinement and edge effect.

Carbon nanoparticles have been an attractive growing interest due to being environmentally friendly, green synthesis, and good biocompatibility for biomedical applications, as compared to conventional nanoparticles that are usually composed of toxic heavy metals. For graphitic carbon nanoparticles, due to sp2-hybridized orbital and hexagonal rings structure, the graphitic carbon nanoparticles enjoy good electrical conductivity and high-intensity photoluminescence, thereby being considered as a new class of carbon nanomaterials showing great potential in a variety of applications.

Recently, a progress in doping graphitic carbon nanoparticles with heteroatoms has reported, such that in-plane substitution of nitrogen atoms is enabled. The N-doped graphitic carbon nanoparticles have been synthesized by hydrothermal route using NH4OH as a nitrogen source, chemical vapor deposition with pyridine as the sole source of both C and N, pyrolysis of citric acid-ethanolamine precursor, and pyrolysis of core-shell nanoparticles followed by dialysis.

### SUMMARY

According to one aspect of the present disclosure, a method of synthesizing N-doped graphitic carbon nanoparticles includes steps of: providing a mixture including a carbon-containing compound and a nitrogen-containing compound; and heating the mixture by microwaves to implement a synthesizing procedure, thereby obtaining a plurality of N-doped graphitic carbon nanoparticles.

According to another aspect of the present disclosure, a method of synthesizing N-doped graphitic carbon nanoparticles includes steps of: providing a mixture including a carbon-containing compound and a nitrogen-containing compound, wherein a mass ratio of the carbon-containing compound to the nitrogen-containing compound is from ⅓ to 3; and heating the mixture to implement a synthesizing procedure, thereby obtaining a plurality of N-doped graphitic carbon nanoparticles.

According to still another aspect of the present disclosure, a method of detecting mercury ions in an aqueous solution includes steps of: adding a plurality of N-doped graphitic carbon nanoparticles, which are obtained by one of the aforementioned methods, into the aqueous solution; irradiating the aqueous solution with ultraviolet or visible light to make the N-doped graphitic carbon nanoparticles emit photoluminescence; and determining a concentration of mercury ions in the aqueous solution according to an intensity of photoluminescence emitted by the N-doped graphitic carbon nanoparticles.

According to yet another aspect of the present disclosure, a cell imaging method includes steps of: adding a plurality of N-doped graphitic carbon nanoparticles, which are obtained by one of the aforementioned methods, into a cell; and irradiating the cell with visible light to make the N-doped graphitic carbon nanoparticles emit photoluminescence.

According to yet still another aspect of the present disclosure, an electrically conductive material includes a plurality of N-doped graphitic carbon nanoparticles obtained by one of the aforementioned methods.

According to yet still another aspect of the present disclosure, an infrared emitting device includes a plurality of N-doped graphitic carbon nanoparticles obtained by one of the aforementioned methods, and an ultraviolet light source configured to irradiate the N-doped graphitic carbon nanoparticles.

### BRIEF DESCRIPTION OF THE DRAWINGS

The present disclosure will become more understood from the detailed description given hereinbelow and the accompanying drawings which are given by way of illustration only and thus are not intending to limit the present disclosure and wherein:

FIG. 1 is a schematic view of synthesizing N-doped graphitic carbon nanoparticles according to an embodiment of the present disclosure;

FIG. 2 is a flowchart of a method of synthesizing N-doped graphitic carbon nanoparticles according to the embodiment of the present disclosure;

FIG. 3 is a planar structure of the N-doped graphitic carbon nanoparticle obtained by the method in FIG. 2;

FIG. 4 is a chart of the number of nitrogen atoms and carbon atoms in the N-doped graphitic carbon nanoparticle, which is obtained by the method in FIG. 2, versus a mass ratio of a carbon-containing compound to a nitrogen-containing compound;

FIG. 5 is a chart of the number of graphitic nitrogen, pyridinic nitrogen and pyrrolic nitrogen in the N-doped graphitic carbon nanoparticle, which is obtained by the method in FIG. 2, versus the mass ratio of the carbon-containing compound to the nitrogen-containing compound;

FIG. 6 is a planar structure of the N-doped graphitic carbon nanoparticle obtained by the method in FIG. 2 with larger mass ratio of the carbon-containing compound to the nitrogen-containing compound;

FIG. 7 is a planar structure of the N-doped graphitic carbon nanoparticle obtained by the method in FIG. 2 with smaller mass ratio of the carbon-containing compound to the nitrogen-containing compound;

FIG. 8 is a chart showing an intensity of photoluminescence emitted by the N-doped graphitic carbon nanoparticle, which is obtained by the method in FIG. 2 with larger mass ratio of the carbon-containing compound to the nitrogen-containing compound, at different wavelengths of irradiation;

FIG. 9 is a chart showing the intensity of photoluminescence emitted by the N-doped graphitic carbon nanoparticle, which is obtained by the method in FIG. 2 with smaller mass ratio of the carbon-containing compound to the nitrogen-containing compound, at different wavelengths of irradiation; and

FIG. 10 is a chart showing the intensity of photoluminescence emitted by the N-doped graphitic carbon nanoparticle, which is obtained by the method in FIG. 2, in aqueous solution having different concentration of mercury ions.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

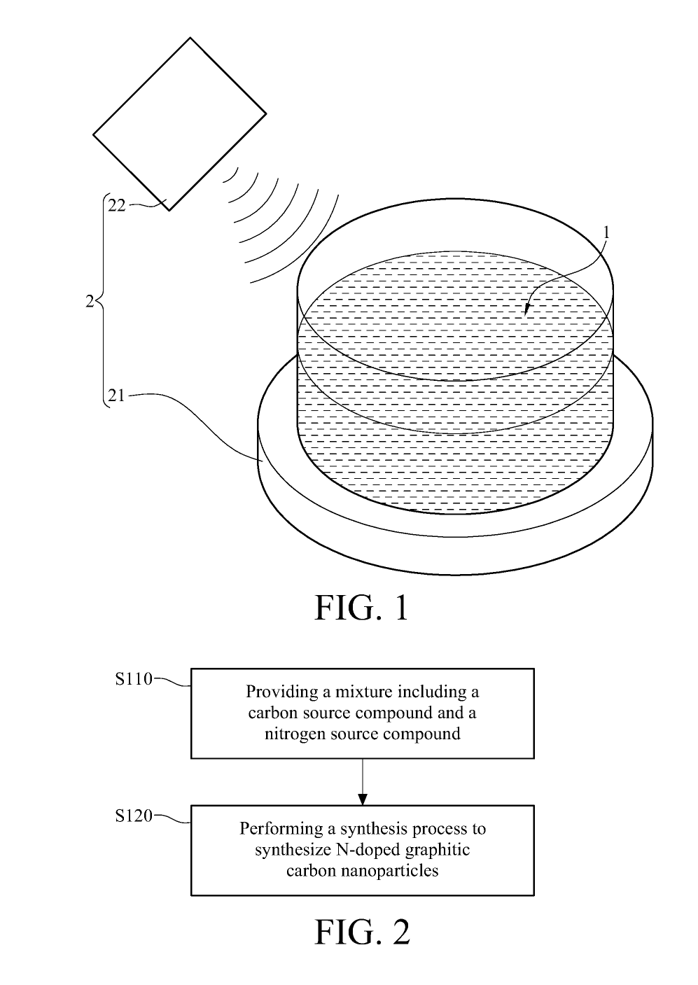

Please refer to FIG. 1 and FIG. 2. FIG. 1 is a schematic view of synthesizing N-doped graphitic carbon nanoparticles according to an embodiment of the present disclosure. FIG. 2 is a flowchart of a method of synthesizing N-doped graphitic carbon nanoparticles according to the embodiment of the present disclosure. In this embodiment, a method of synthesizing N-doped graphitic carbon nanoparticles is disclosed. The method of synthesizing N-doped graphitic carbon nanoparticles includes steps S110 and S120.

In the step S110, a mixture 1 including a carbon-containing compound and a nitrogen-containing compound is provided. The mixture 1 includes citric acid (C6H8O7), urea (CN2H4O) and water (Milli-Q water). In this embodiment, the citric acid is regarded as the carbon-containing compound, and the urea is regarded as the nitrogen-containing compound. The carbon-containing compound is selected from the group consisting of citric acid, glucose (C6H12O6), ferric citrate, ammonium citrate, ammonium ferric citrate, sucrose and combination thereof. The nitrogen-containing compound is selected from the group consisting of urea, glycine and combination thereof. It is worth nothing that the aforementioned compounds are not limited to pure compounds; in detail, a polymer of the aforementioned compound or a compound of larger molecular weight including the aforementioned compound is within the scope of the aforementioned compound. For example, when the carbon-containing compound is glucose, the carbon-containing compound is either glucose solution or starch. When the nitrogen-containing compound is glycine, the nitrogen-containing compound is either glycine solution or protein.

In the step S120, a synthesizing procedure is implemented to obtain a plurality of N-doped graphitic carbon nanoparticles. In this embodiment, a microwave equipment 2 is used to heat the mixture 1. The microwave equipment 2 includes a rotary tray 21 and a microwave emitter 22. The mixture 1 is positioned on the rotary tray 21 and receives microwaves from the microwave emitter 22 so as to make the carbon-containing compound and the nitrogen-containing compound react with each other, thereby generating the N-doped graphitic carbon nanoparticles. When the microwave emitter 22 irradiates the mixture 1 with microwaves, the rotary tray 21 rotates relative to the microwave emitter 22 so that it is favorable for every side of the mixture 1 evenly receiving microwaves to prevent incomplete chemical reaction at some parts of the mixture 1.

In some embodiments, the synthesizing procedure (step S120) is implemented at a temperature of 156° C. to 250° C. Therefore, it is favorable for preventing an overly high synthesis temperature, so that the synthesis temperature is close to or lower than the melting points of the carbon-containing compound and the nitrogen-containing compound, thereby preventing carbonization of the carbon-containing compound.

Furthermore, in the synthesizing procedure of this embodiment, the mixture 1 is heated by microwave irradiation, but the present disclosure is not limited thereto. In some embodiments, the mixture is heated by infrared radiation, double steaming or baking.

The following specific embodiments, including synthesis of the N-doped graphitic carbon nanoparticles, physicochemical properties of the N-doped graphitic carbon nanoparticles and applications of the N-doped graphitic carbon nanoparticles, are provided for further describing the present disclosure.

### Embodiments of the Present Disclosure

An unreacted mixture, including 100 g (grams) of a total mass of citric acid and urea, 10 g of Milli-Q water and several grams of catalyst, is provided. The catalyst is ammonium sulfate, sulfuric acid or phosphoric acid. Six embodiments with different mass ratios of citric acid to urea are given hereinbelow.

In the first (1st) embodiment, a mass ratio of citric acid to urea (C/U mass ratio) is 3 (3:1). That is, the unreacted mixture includes 75 g of citric acid and 25 g of urea.

In the second (2nd) embodiment, a mass ratio of citric acid to urea is 2 (2:1). That is, the unreacted mixture includes 66.7 g of citric acid and 33.3 g of urea.

In the third (3rd) embodiment, a mass ratio of citric acid to urea is 1 (1:1). That is, the unreacted mixture includes 50 g of citric acid and 50 g of urea.

In the fourth (4th) embodiment, a mass ratio of citric acid to urea is ⅔ (2:3). That is, the unreacted mixture includes 40 g of citric acid and 60 g of urea.

In the fifth (5th) embodiment, a mass ratio of citric acid to urea is ½ (1:2). That is, the unreacted mixture includes 33.3 g of citric acid and 66.7 g of urea.

In the sixth (6th) embodiment, a mass ratio of citric acid to urea is ⅓ (1:3). That is, the unreacted mixture includes 25 g of citric acid and 75 g of urea.

The unreacted mixtures in the first embodiment through the sixth embodiment are positioned on the rotary tray 21 of the microwave equipment 2 in FIG. 2, and the synthesizing procedure is implemented in the microwave equipment 2. The microwave emitter 22 has a maximal power of 6000 watts, and the rotary tray 21 has a maximal speed of 60 rpm. The unreacted mixtures are irradiated by the microwave emitter 22 so as to be heated up to about 250° C., and thus the citric acid reacts with the urea. A time of the synthesizing procedure is about 5 minutes. When the synthesizing procedure is completed, the reacted mixture includes multiple N-doped graphitic carbon nanoparticles, residual citric acid, residual urea and some side products.

The reacted mixture is sieved by a metallic screen and a centrifuge after the synthesizing procedure to remove the residual citric acid, the residual urea and the side products. Finally, the N-doped graphitic carbon nanoparticles without any impurity are obtained.

[Structure and Composition of the N-Doped Graphitic Carbon Nanoparticles]

An average particle size of the N-doped graphitic carbon nanoparticle, which is obtained by the method in FIG. 2, is about 10 nanometers (nm). The average particle sizes of the N-doped graphitic carbon nanoparticle in the first embodiment through the sixth embodiment are shown in Table I. With the decrease of the mass ratio of citric acid to urea in the unreacted mixture, the average particle size of the N-doped graphitic carbon nanoparticle generated by the mixture is decreased. However, when the mass ratio of citric acid to urea is smaller than ⅔, the average particle size of the N-doped graphitic carbon nanoparticle is not decreased significantly. This result reveals that the N-doped graphitic carbon nanoparticle generally maintains a uniform size of approximately 3.5 nm with increasing the urea concentration in the unreacted mixture.

TABLE I

| | 1st | 2nd | 3rd |
|---|---|---|---|
| | embodiment | embodiment | embodiment |
| Average particle size (nm) | 5.5 | 4.6 | 4.2 |
| | 4th | 5th | 6th |
| | embodiment | embodiment | embodiment |
| Average particle size (nm) | 3.5 | About 3.5 | About 3.5 |

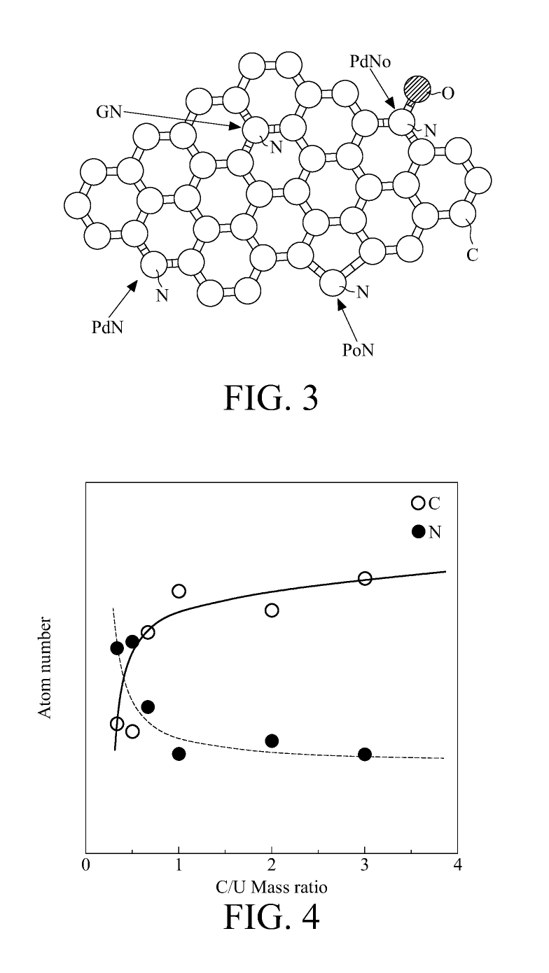

FIG. 3 is a planar structure of the N-doped graphitic carbon nanoparticle obtained by the method in FIG. 2. According to the chemical bond between the nitrogen atom and the carbon atom as well as the valence of the nitrogen atom in the chemical bond, the nitrogen atoms in the N-doped graphitic carbon nanoparticle are divided into graphitic nitrogen (graphitic N, GN), pyridinic nitrogen (pyridinic N, PdN), pyrrolic nitrogen (pyrrolic N, PoN) and pyridinic-nitrogen-oxide (pyridinic-N-oxide, PdNo). The graphitic nitrogen is a nitrogen atom located inside the hexagonal rings of the carbon layer. Both the pyridinic nitrogen and the pyrrolic nitrogen are a nitrogen atom located at the edge of the carbon layer. The pyridinic-nitrogen-oxide is a nitrogen atom located at the edge of the carbon layer and is bonded to an oxygen atom.

FIG. 4 is a chart of the number of nitrogen atoms and carbon atoms in the N-doped graphitic carbon nanoparticle, which is obtained by the method in FIG. 2, versus a mass ratio of a carbon-containing compound to a nitrogen-containing compound. With the decrease of the mass ratio of citric acid to urea in the unreacted mixture, the N-doped graphitic carbon nanoparticles synthesized from the mixture include more nitrogen atoms and fewer carbon atoms. When the mass ratio of citric acid to urea is smaller than 1, it is observed that the N-doped graphitic carbon nanoparticles include much more nitrogen atoms and fewer carbon atoms. When the mass ratio of citric acid to urea is ⅓, the nitrogen atoms in the N-doped graphitic carbon nanoparticles are 74% more than the carbon atoms therein.

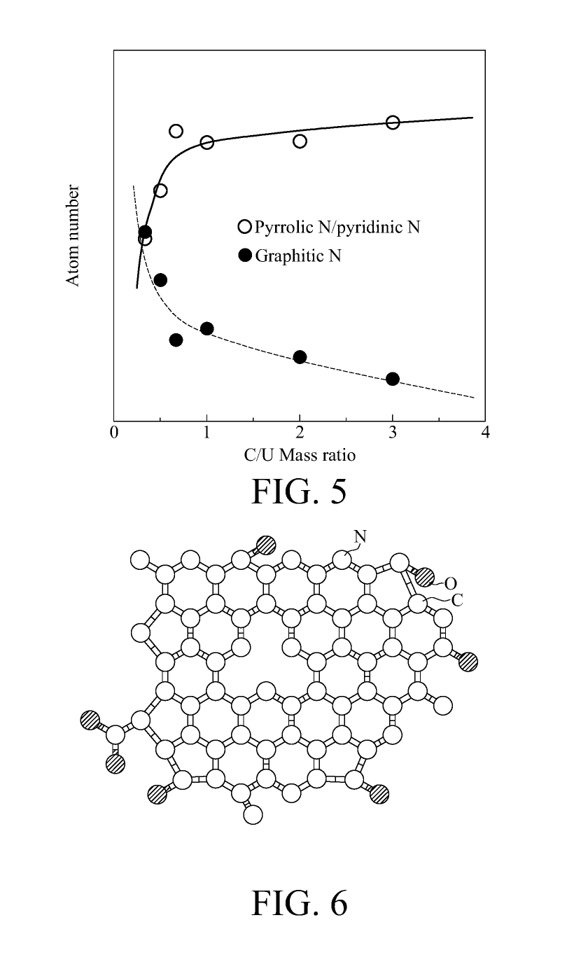

FIG. 5 is a chart of the number of graphitic nitrogen, pyridinic nitrogen and pyrrolic nitrogen in the N-doped graphitic carbon nanoparticle, which is obtained by the method in FIG. 2, versus the mass ratio of the carbon-containing compound to the nitrogen-containing compound. With the decrease of the mass ratio of citric acid to urea in the unreacted mixture, the N-doped graphitic carbon synthesized from the mixture includes more graphitic nitrogens and less pyridinic nitrogens and pyrrolic nitrogens. When the mass ratio of citric acid to urea is smaller than 1, it is observed that the N-doped graphitic carbon nanoparticles include much more graphitic nitrogens.

A relationship between the mass ratio of citric acid to urea in the unreacted mixture and the planar structure of the N-doped graphitic carbon nanoparticle is described below. FIG. 6 is a planar structure of the N-doped graphitic carbon nanoparticle obtained by the method in FIG. 2 with larger mass ratio of the carbon-containing compound to the nitrogen-containing compound. When the mass ratio of citric acid to urea is from ⅔ to 3 (the first embodiment through the fourth embodiment), the N-doped graphitic carbon nanoparticles include more pyridinic nitrogens and pyrrolic nitrogens. Due to less graphitic nitrogens in the N-doped graphitic carbon nanoparticles, the arrangement of the carbon atoms is still similar to the hexagonal rings of graphene. The N-doped graphitic carbon nanoparticle having the planar structure in FIG. 6 is called N-doped graphene quantum dot.

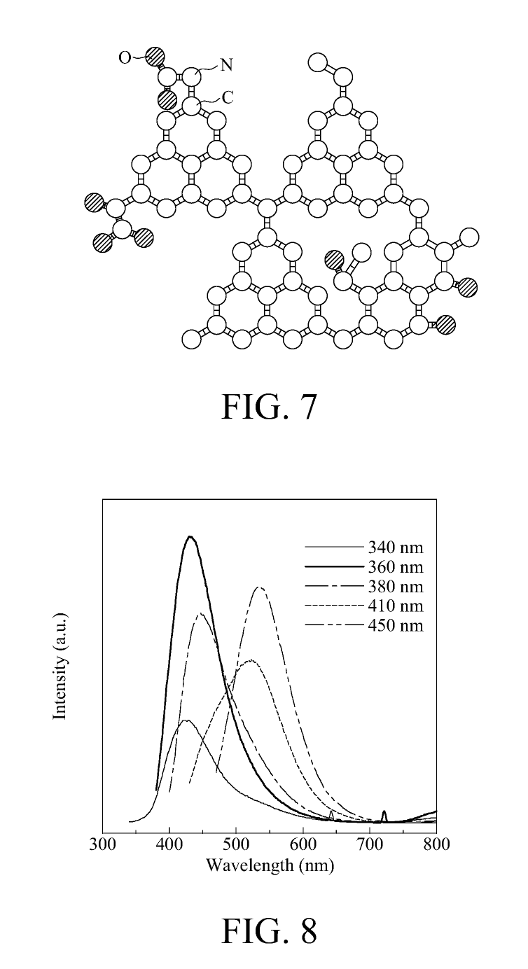

FIG. 7 is a planar structure of the N-doped graphitic carbon nanoparticle obtained by the method in FIG. 2 with smaller mass ratio of the carbon-containing compound to the nitrogen-containing compound. When the mass ratio of citric acid to urea is from ⅓ to ½ (the fifth embodiment through the sixth embodiment), the N-doped graphitic carbon nanoparticles include more graphitic nitrogens. Thus, most of the carbon atoms inside the hexagonal rings are replaced with nitrogen atoms so as to form defects. The N-doped graphitic carbon nanoparticle having the planar structure in FIG. 7 is called graphitic carbon nitride quantum dot.

Accordingly, if the N-substitution amount reaches an appropriate C/U mass ratio, the N-substitution could vastly tailor the band structure and even create novel and unique atomic structure of the N-doped graphitic carbon nanoparticle. A development of tunable atomic structure, from N-doped graphene quantum dots (larger C/U mass ratio) to graphitic carbon nitride quantum dots (smaller C/U mass ratio), is accomplished in the aforementioned embodiments.

[Physicochemical Properties of the N-Doped Graphitic Carbon Nanoparticles]

An electrical resistivity of the N-doped graphitic carbon nanoparticle in the first embodiment through the sixth embodiment is shown in Table II. The unit of the electrical resistivity is ohm centimeters (Ω·cm). The electrical resistivity of the N-doped graphitic carbon nanoparticle is able to be determined by the mass ratio of citric acid to urea. Thus, to meet specific requirements, the methods of the present disclosure provide the N-doped graphitic carbon nanoparticles having various levels of electrical resistivity.

TABLE II

| | 1st | 2nd | 3rd |
|---|---|---|---|
| | embodiment | embodiment | embodiment |
| Electrical resistivity (Ω · cm) | 0.426 | 0.290 | 0.230 |
| | 4th | 5th | 6th |
| | embodiment | embodiment | embodiment |
| Electrical resistivity (Ω · cm) | 0.209 | 0.187 | 0.312 |

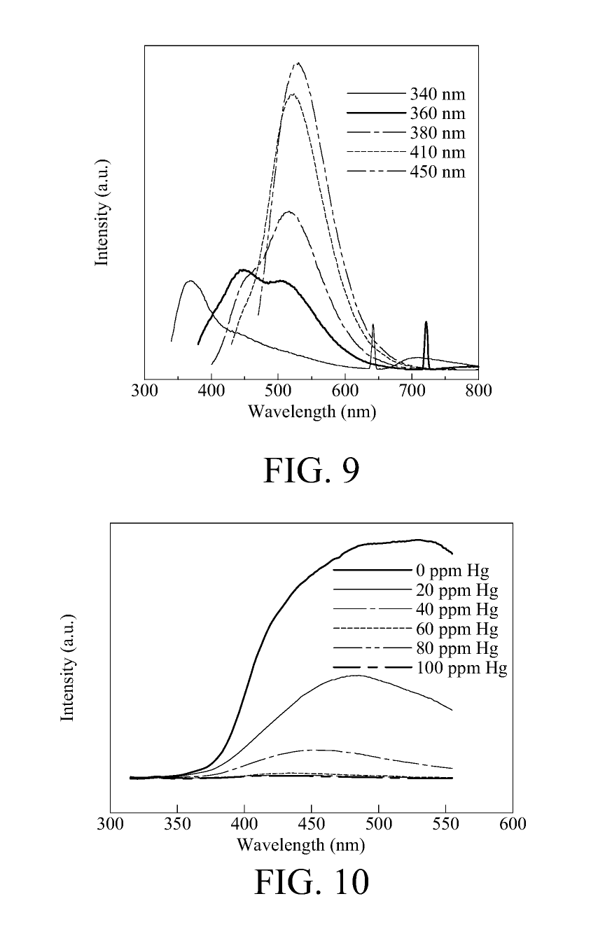

FIG. 8 is a chart showing an intensity of photoluminescence emitted by the N-doped graphitic carbon nanoparticle, which is obtained by the method in FIG. 2 with larger mass ratio of the carbon-containing compound to the nitrogen-containing compound, at different wavelengths of irradiation. FIG. 9 is a chart showing the intensity of photoluminescence emitted by the N-doped graphitic carbon nanoparticle, which is obtained by the method in FIG. 2 with smaller mass ratio of the carbon-containing compound to the nitrogen-containing compound, at different wavelengths of irradiation. The N-doped graphitic carbon nanoparticles are suspended in aqueous solution, and the N-doped graphitic carbon nanoparticles are irradiated with light at specific wavelength so as to emit photoluminescence at specific wavelength.

Take the N-doped graphitic carbon nanoparticles in the first embodiment for example. In FIG. 8, when the N-doped graphitic carbon nanoparticles are irradiated with light at a wavelength of 340 nm, the N-doped graphitic carbon nanoparticles emit a photoluminescence at a maximal wavelength of about 430 nm. When the N-doped graphitic carbon nanoparticles are irradiated with light at the wavelength of 360 nm, the N-doped graphitic carbon nanoparticles emit the photoluminescence at the maximal wavelength of about 440 nm. When the N-doped graphitic carbon nanoparticles are irradiated with light at the wavelength of 380 nm, the N-doped graphitic carbon nanoparticles emit the photoluminescence at the maximal wavelength of about 450 nm. When the N-doped graphitic carbon nanoparticles are irradiated with light at the wavelength of 410 nm, the N-doped graphitic carbon nanoparticles emit the photoluminescence at the maximal wavelength of about 520 nm. When the N-doped graphitic carbon nanoparticles are irradiated with light at the wavelength of 450 nm, the N-doped graphitic carbon nanoparticles emit the photoluminescence at the maximal wavelength of about 545 nm.

Furthermore, take the N-doped graphitic carbon nanoparticles in the sixth embodiment for example. In FIG. 9, when the N-doped graphitic carbon nanoparticles are irradiated with light at the wavelength of 340 nm, the N-doped graphitic carbon nanoparticles emit the photoluminescence at the maximal wavelength of about 370 nm. When the N-doped graphitic carbon nanoparticles are irradiated with light at the wavelength of 360 nm, the N-doped graphitic carbon nanoparticles emit the photoluminescence at the maximal wavelength of about 445 nm. When the N-doped graphitic carbon nanoparticles are irradiated with light at the wavelength of 380 nm, the N-doped graphitic carbon nanoparticles emit the photoluminescence at the maximal wavelength of about 520 nm. When the N-doped graphitic carbon nanoparticles are irradiated with light at the wavelength of 410 nm, the N-doped graphitic carbon nanoparticles emit the photoluminescence at the maximal wavelength of about 515 nm. When the N-doped graphitic carbon nanoparticles are irradiated with light at the wavelength of 450 nm, the N-doped graphitic carbon nanoparticles emit the photoluminescence at the maximal wavelength of about 535 nm.

[Applications of the N-Doped Graphitic Carbon Nanoparticles]

As shown in Table II mentioned above, the electrical resistivity of the N-doped graphitic carbon nanoparticle is able to be determined by the mass ratio of citric acid to urea. Therefore, the N-doped graphitic carbon nanoparticles obtained by the methods of the present disclosure are able to be used as an electrically conductive material, such as a conductive film in an electronic device. Specifically, the N-doped graphitic carbon nanoparticles are spread on a dielectric substrate to form the conductive film.

Moreover, referring to FIG. 8 and FIG. 9, When the N-doped graphitic carbon nanoparticles are irradiated with an ultraviolet (UV) light at a wavelength of 360 nm, the N-doped graphitic carbon nanoparticles emit the photoluminescence including a secondary wavelength peak of about 720 nm, and the secondary wavelength peak is within the range of infrared light. Therefore, the N-doped graphitic carbon nanoparticles are applicable to an infrared emitter for medical treatment and healthcare. For example, an infrared emitting device may include the N-doped graphitic carbon nanoparticles and an UV light source. The N-doped graphitic carbon nanoparticles are obtained by the methods of the present disclosure. The UV light source is configured to irradiate the N-doped graphitic carbon nanoparticles with UV light so as to make the N-doped graphitic carbon nanoparticles emit infrared light.

The N-doped graphitic carbon nanoparticles are also applicable to the detection of heavy metal ions in the aqueous solution. FIG. 10 is a chart showing the intensity of photoluminescence emitted by the N-doped graphitic carbon nanoparticle, which is obtained by the method in FIG. 2, in an aqueous solution having different concentration of mercury ions. A method of detecting mercury ions (Hg+ and Hg2+) in the aqueous solution includes several steps. In a step, the N-doped graphitic carbon nanoparticles, which are obtained by the methods of the present disclosure, are added into the aqueous solution. In another step, the aqueous solution is irradiated with ultraviolet or visible light to make the N-doped graphitic carbon nanoparticles emit photoluminescence. In another step, the concentration of mercury ions in the aqueous solution is determined by the intensity of photoluminescence emitted by the N-doped graphitic carbon nanoparticles. Since both the pyridinic nitrogens and the pyrrolic nitrogens are able to combine with the mercury ions, the photoluminescence emitted by the N-doped graphitic carbon nanoparticles has lower intensity when the aqueous solution includes more mercury ions (high concentration).

The N-doped graphitic carbon nanoparticles are also applicable to cell imaging. A cell imaging method includes several steps. In a step, the N-doped graphitic carbon nanoparticles, which are obtained by the methods of the present disclosure, are added into a cell. The cell is then irradiated with visible light to make the N-doped graphitic carbon nanoparticles therein emit photoluminescence. For example, a Bacillus subtilis in a culture medium is treated with phosphate-buffered saline (PBS) including N-doped graphitic carbon nanoparticles and then incubated for 2 hours. During the incubation, the Bacillus subtilis eats the N-doped graphitic carbon nanoparticles; thus, when the Bacillus subtilis is irradiated with green light, a cell image shows Bacillus subtilis which emits photoluminescence.

According to the disclosure, both the number of atoms and the types of carbon-nitrogen bond (graphitic nitrogen, pyridinic nitrogen and pyrrolic nitrogen) in the N-doped graphitic carbon nanoparticles can be analyzed by X-ray Photoelectron Spectroscopy (XPS) and X-ray diffraction (XRD). The electrical resistivity of the N-doped graphitic carbon nanoparticles can be analyzed by a four-probe resistance measurement. The intensity of photoluminescence can be analyzed by a fluorescence spectrophotometer.

According to the disclosure, a mixture including carbon-containing compound and nitrogen-containing compound is heated by microwaves so as to synthesize N-doped graphitic carbon nanoparticles. The number of nitrogen atoms, the types of carbon-nitrogen bond and the lattice structure of the N-doped graphitic carbon nanoparticle are changeable by increasing and decreasing the mass ratio of the carbon-containing compound to the nitrogen-containing compound in the mixture.

According to the disclosure, the methods of synthesizing N-doped graphitic carbon nanoparticles are able to precisely control the physicochemical properties of synthesized N-doped graphitic carbon nanoparticles, such as the electrical resistivity and the intensity of photoluminescence. Therefore, the N-doped graphitic carbon nanoparticles obtained by the methods of the present disclosure are widely applicable to different fields, such as electrically conductive material, infrared emitting device, cell imaging and mercury ions detection.

The embodiments are chosen and described in order to best explain the principles of the present disclosure and its practical applications, to thereby enable others skilled in the art best utilize the present disclosure and various embodiments with various modifications as are suited to the particular use being contemplated. It is intended that the scope of the present disclosure is defined by the following claims and their equivalents.

What is claimed is:

1. A method of synthesizing N-doped graphitic carbon nanoparticles, comprising:
providing a mixture comprising a carbon-containing compound and a nitrogen-containing compound; and
heating the mixture by microwaves to implement a synthesizing procedure, thereby obtaining a plurality of N-doped graphitic carbon nanoparticles.

2. The method according to claim 1, wherein a mass ratio of the carbon-containing compound to the nitrogen-containing compound is from ⅓ to 3.

3. The method according to claim 2, wherein the mass ratio of the carbon-containing compound to the nitrogen-containing compound is smaller than 1.

4. The method according to claim 2, wherein the mass ratio of the carbon-containing compound to the nitrogen-containing compound is from ⅔ to 3.

5. The method according to claim 2, wherein the mass ratio of the carbon-containing compound to the nitrogen-containing compound is from ⅓ to ½.

6. The method according to claim 1, wherein the carbon-containing compound is selected from the group consisting of citric acid, glucose, ferric citrate, ammonium citrate, ammonium ferric citrate, sucrose and combination thereof.

7. The method according to claim 1, wherein the nitrogen-containing compound is selected from the group consisting of urea, glycine and combination thereof.

8. The method according to claim 1, wherein the synthesizing procedure is implemented at a temperature of 156° C. to 250° C.

9. The method according to claim 1, wherein a size of the N-doped graphitic carbon nanoparticles is from 3.5 nm to 10.0 nm.

10. A method of synthesizing N-doped graphitic carbon nanoparticles, comprising:
providing a mixture comprising a carbon-containing compound and a nitrogen-containing compound, wherein a mass ratio of the carbon-containing compound to the nitrogen-containing compound is from ⅓ to 3; and
heating the mixture to implement a synthesizing procedure, thereby obtaining a plurality of N-doped graphitic carbon nanoparticles.

11. The method according to claim 10, wherein the mass ratio of the carbon-containing compound to the nitrogen-containing compound is smaller than 1.

12. The method according to claim 10, wherein the mass ratio of the carbon-containing compound to the nitrogen-containing compound is from ⅔ to 3.

13. The method according to claim 10, wherein the mass ratio of the carbon-containing compound to the nitrogen-containing compound is from ⅓ to ½.

14. The method according to claim 10, wherein the carbon-containing compound is selected from the group consisting of citric acid, glucose, ferric citrate, ammonium citrate, ammonium ferric citrate, sucrose and combination thereof.

15. The method according to claim 10, wherein the nitrogen-containing compound is selected from the group consisting of urea, glycine and combination thereof.

16. The method according to claim 10, wherein the synthesizing procedure is implemented at a temperature of 156° C. to 250° C.

17. A method of detecting mercury ions in an aqueous solution, comprising:
adding a plurality of N-doped graphitic carbon nanoparticles, which are obtained by the method according to claim 1, into the aqueous solution;
irradiating the aqueous solution with ultraviolet or visible light to make the N-doped graphitic carbon nanoparticles emit photoluminescence; and
determining a concentration of mercury ions in the aqueous solution according to an intensity of photoluminescence emitted by the N-doped graphitic carbon nanoparticles.

18. A cell imaging method, comprising:
adding a plurality of N-doped graphitic carbon nanoparticles, which are obtained by the method according to claim 1, into a cell; and
irradiating the cell with visible light to make the N-doped graphitic carbon nanoparticles emit photoluminescence.

19. An electrically conductive material, comprising a plurality of N-doped graphitic carbon nanoparticles obtained by the method according to claim 1.

20. An infrared emitting device, comprising:
a plurality of N-doped graphitic carbon nanoparticles obtained by the method according to claim 1; and
an ultraviolet light source configured to irradiate the N-doped graphitic carbon nanoparticles.
